(19) United States
(12) Patent Application Publication
(10) Pub. No.: US 2010/0079337 A1
(43) Pub. Date: Apr. 1, 2010

(54) PORTABLE ELECTRONIC DEVICE, AND SYSTEM AND METHOD FOR TRACKING POSITIONS OF THE SAME

(75) Inventors: Jun-Ting Shiau, Taipei City (TW); Ta-Yung Lee, Taipei City (TW); Jen-Hao Hsu, Taipei City (TW); Chia-Chin Yu, Taipei City (TW)

Correspondence Address: APEX JURIS, PLLC, 12733 LAKE CITY WAY NORTHEAST, SEATTLE, WA, 98125, US

(73) Assignee: MITAC TECHNOLOGY CORP., Taipei City (TW)

(21) Appl. No.: 12/242,510

(22) Filed: Sep. 30, 2008

(51) Int. Cl. G01S 5/00; H04Q 5/22

(52) U.S. Cl. 342/357.07; 340/10.42

(57) ABSTRACT

A system and method is provided to track positions of a portable electronic device. Different communication modules capable of retrieving position signals are enabled selectively according to the status/type of position signals of the portable electronic device. All of the different communication modules are enabled when the portable electronic device locates around a boundary between different regions that require different communication modules to obtain geography information. Therefore, by means of seamless transferring operation between different communication modules, a remote manager may be able to continuously monitor the positions of the portable electronic device.

### BACKGROUND OF THE INVENTION

1. Field of Invention

The present invention relates to a system and method for tracking positions of a portable electronic device, and more particularly, to a seamless, trackable portable electronic device, and a system and method for seamlessly tracking positions of the portable electronic device.

2. Related Art

The global positioning system (GPS) is a very popular position tracking system with the help of satellites. However, when the satellites and the receiver are separated by buildings, the positioning signals cannot be received by the receiver due to the obstacles. In other words, once the user goes indoors, the GPS cannot function properly.

To solve this problem, the prior art provides a positioning device that combines the GPS and a short-distance wireless communication protocol. It enables the user to select an appropriate position tracking method according to his position. For example, when the user is outdoors, the GPS is used for outdoor positioning information. When the user is indoors, an ultra wide band wireless communication positioning module is used to provide indoor positioning information.

In the field of remote monitoring and tracking, the above-mentioned technique cannot provide the indoor and outdoor positioning information to a remote monitor without any interruption. This is because the conventional positioning device provides real-time positioning information to the user, i.e., the holder of the positioning system. However, the user has to switch between different modes for receiving the positioning information. Therefore, during the remote monitoring and tracking, the position information of the user cannot be continuously provided to the remote monitor if the user does not immediately switch from the GPS to the ultra wide band wireless communication positioning module as he goes from outdoors to indoors.

### SUMMARY OF THE INVENTION

To resolve the aforesaid technical problems of the prior art, the present invention provides a seamless, trackable portable electronic device, and a system and method for seamlessly tracking positions of the portable electronic device.

In an embodiment of the present invention, a position tracking system comprises a portable electronic device, at least one RFID reader and a remote monitoring server. The portable electronic device has a signal receiving module, a first communicating module, an active radio frequency identification (RFID) tag and a controlling module. The signal receiving module receives a satellite positioning signal in a first region. The first communicating module emits the satellite positioning signal. The active RFID tag emits an identification (ID) code signal. And the controlling module enables/disables the signal receiving module and the active RFID tag. The at least one RFID reader is located in a second region for receiving the ID code signal emitted by the active RFID tag, and emits an radio frequency (RF) positioning signal after receiving the ID code signal. The remote monitoring server comprises a second communicating module and a position determining module. The second communicating module establishes a communicating connection with the first communicating module for receiving the satellite positioning signal emitted by the first communicating module and for receiving the RF positioning signal emitted by the RFID reader. The position determining module uses the satellite positioning signal received by the second communicating module to determine whether the portable electronic device is far from the first region and close to the second region when the controlling module enables the signal receiving module; wherein the remote monitoring server sends a first command via the second communicating module to the first communicating module when the portable electronic device is close to the second region, and the controlling module enables the active RFID tag according to the first command received by the first communicating module.

In another embodiment of the present invention, a position tracking method is provided for tracking positions of a portable electronic device. The portable electronic device has a signal receiving module to receive a satellite positioning signal in a first region and also has an active RFID tag to send an ID code signal for at least one RFID reader in a second region. The RFID reader sends an RF positioning signal after receiving the ID code signal. The method comprises the following steps. First of all, establish a communicating connection with the portable electronic device. Next, receive the satellite positioning signal sent by the portable electronic device. Then, determine whether the portable electronic device is far from the first region and close to the second region according to the satellite positioning signal; wherein when the portable electronic device is far from the first region and close to the second region, a first command is sent to the portable electronic device to enable the active RFID tag for sending the ID code signal to the RFID reader. Finally, receive the RF positioning signal sent by the RFID reader.

In another embodiment of the present invention, a portable electronic device is used for communicating with a remote monitoring system. The portable electronic device comprises a signal receiving module, a first communicating module, an active RFID tag and a controlling module. The signal receiving module receives a satellite positioning signal in a first region. The first communicating module establishes a communicating connection with the remote monitoring system and sends the satellite positioning signal to the remote monitoring system. The active RFID tag sends an ID code signal for at least one RFID reader in a second region to read; the RFID reader also sends an RF positioning to the remote monitoring system after reading the ID code signal. And the controlling module enables/disables the signal receiving module and the active RFID tag; wherein when the remote monitoring system determines that the portable electronic device is far from the first region and close to the second region, the remote monitoring system sends a first command to the first communicating module and the controlling module enables the active RFID tag following to the first command received by the first communicating module.

The major differences between the present invention and the prior art are explained as follows. The present invention provides a portable electronic device that is equipped with different communication modules. The different communication modules capable of retrieving position signals are enabled selectively according to the status/type of position signals of the portable electronic device. All of the different communication modules are enabled when the portable electronic device locates around a boundary between different regions that require different communication modules to obtain geography information. Therefore, by means of seamless transferring operation between different communication modules, a remote manager may be able to continuously monitor the positions of the portable electronic device.

These and other features, aspects, and advantages of the present invention will become better understood with reference to the following description and appended claims. It is to be understood that both the foregoing general description and the following detailed description are examples, and are intended to provide further explanation of the invention as claimed.

### BRIEF DESCRIPTION OF THE DRAWINGS

The invention will become more fully understood from the detailed description given herein below illustration only, and thus is not limitative of the present invention, and wherein:

FIG. 1 is a block diagram of the position tracking system according to an embodiment of the invention;

FIG. 2 is a flowchart of the position tracking method according to an embodiment of the invention;

FIGS. 3A to 3D show the format of the command sent from the remote monitoring server to the portable electronic device according to the invention; and

FIG. 4 is a flowchart of the position tracking method according to another embodiment of the invention.

### DETAILED DESCRIPTION OF THE INVENTION

The present invention will be apparent from the following detailed description, which proceeds with reference to the accompanying drawings, wherein the same references relate to the same elements.

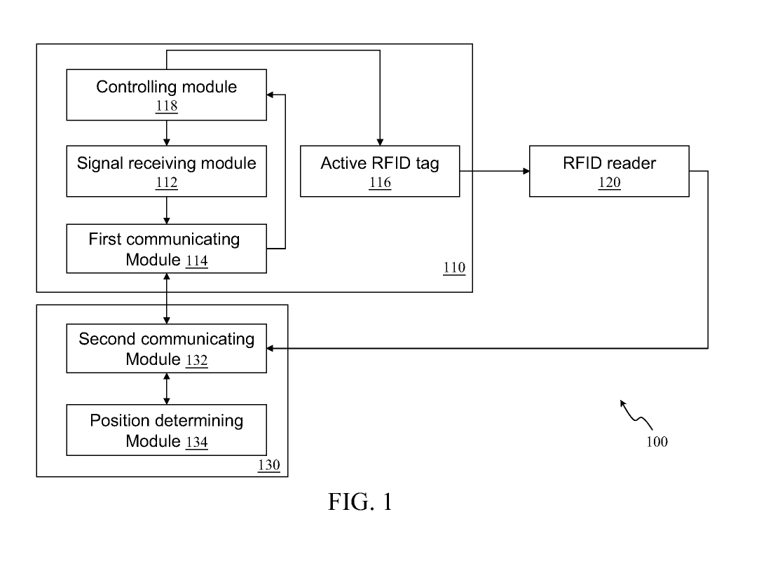

FIG. 1 is a block diagram of the disclosed position tracking system according to an embodiment of the invention. As shown in the drawing, the position tracking system 100 includes a portable electronic device 110, at least one radio frequency identification (RFID) reader 120, and a remote monitoring server 130. The portable electronic device 110 includes a signal receiving module 112, a first communicating module 114, an active RFID tag 116, and a controlling module 118. The remote monitoring server 130 includes a second communicating module 132 and a position determining module 134. It should be noted that the electronic device 110 can be a mobile phone, a personal digital assistant (PDA), or some other electronic device with the communication function. It is not restricted by the invention.

As described above, the signal receiving module 112, such as a GPS chip, is used to receive satellite positioning signals emitted by satellites in a first region (outdoor space without building obstacles). The first communicating module 114 is used to send the satellite positioning signals to the remote monitoring server 130. More explicitly, the satellite positioning signals are transmitted to the remote monitoring server 130 by the third generation mobile communication (3G), general packet radio service (GPRS), wireless fidelity (Wi-Fi), worldwide interoperability for microwave access (Wimax), short message service (SMS) or satellite signals. The invention does not impose any restriction on the way the first communicating module 114 transmits satellite positioning signals.

The active RFID tag 116 sends identification (ID) code signals for the RFID reader 120 to read. The RFID reader 120 is located in a second region (e.g., indoor space) that the signals emitted by the satellites cannot reach. Moreover, after the RFID reader 120 reads the ID code emitted by the active RFID tag 116, it sends a radio frequency (RF) positioning signal to the remote monitoring server 130. The remote monitoring server 130 can obtain the location of the RFID reader 120 according to the RF positioning signal, thereby finding out precisely the location of the user of the electronic device 110.

The controlling module 118 controls the on and off states of the signal receiving module 112 and the active RFID tag 116. The following example describes in detail how the controlling module 118 enables the signal receiving module 112 and the active RFID tag 116.

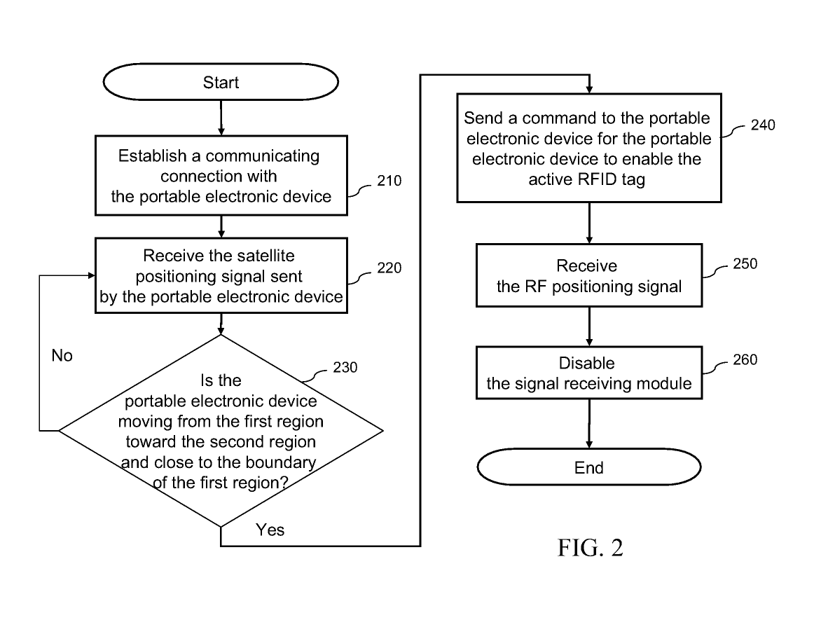

FIG. 2 is a flowchart showing the steps of the position tracking method according to an embodiment of the invention. Please refer simultaneously to FIGS. 1 and 2. In the initial state of the portable electronic device 110, the controlling module 118 first enables the signal receiving module 112. If the portable electronic device 110 is in the above-mentioned first region at the moment, then the satellite positioning signals from the satellites can be received by the signal receiving module 112. Moreover, the remote monitoring server 130 establishes communications with the portable electronic device 110 via the second communicating module 132 (step 210). The second communicating module 132 receives the satellite positioning signals transmitted by the first communicating module 114 (step 220). The location of the portable electronic device 110 is thus obtained. In particular, the remote monitoring server 130 establishes communications with the first communicating module 114 via the second communicating module 132.

Afterwards, the remote monitoring server 130 uses the position determining module 134 to determine from the satellite positioning signals whether the portable electronic device 110 is moving from the first region to the second region and close the boundary of the first region (step 230). More explicitly, the remote monitoring server 130 stores geography information of the first and second regions. Therefore, the position determining module 134 can use such information to determine whether the portable electronic device 110 is close to the boundary of the first region and about to enter the second region. In the geography information stored in the remote monitoring server 130, a specific range is defined between the first region and the second region. When the position determining module 134 determines according to the satellite positioning signals continuously received by the second communicating module 132 that the portable electronic device 110 is entering from the first region to this range, the portable electronic device 110 is considered as moving from the first region to the second region. In other words, the position determining module 134 can use the satellite positioning signals continuously received by the second communicating module 132 to determine the motion of the portable electronic device 110. Therefore, it can determine whether the user of the portable electronic device 110 is going from outdoors to indoors.

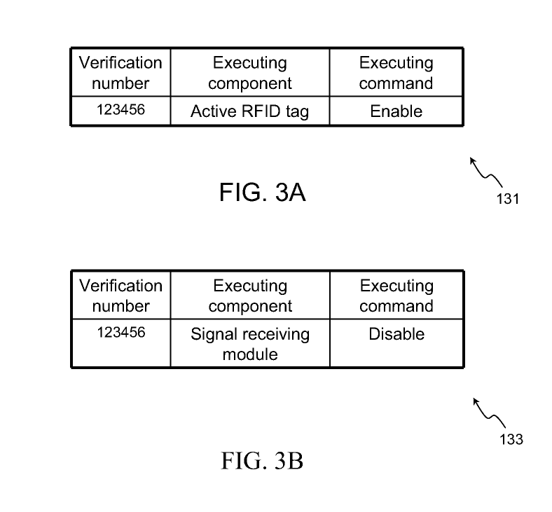

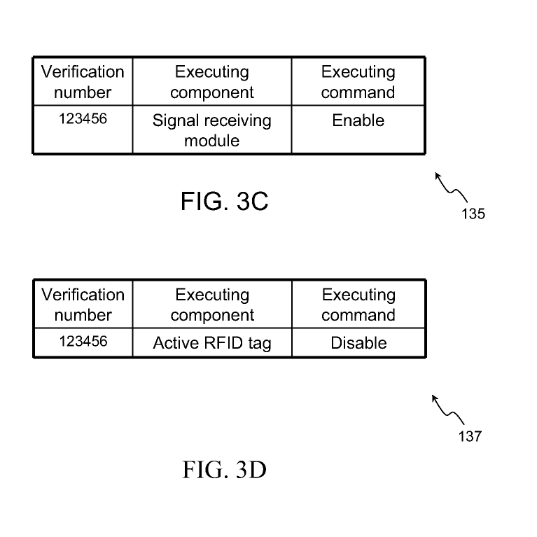

As described above, when the position determining module 134 determines from the satellite positioning signals received by the second communicating module 132 that the portable electronic device 110 is not far from the first region, no action is taken. On the other hand, if the position determining module 134 determines from the satellite positioning signals received by the second communicating module 132 that the portable electronic device 110 is far from the first region and close to the second region, the second communicating module 132 sends a command 131 (as shown in FIG. 3A) to the portable electronic device 110. The controlling module 118 of the portable electronic device 110 follows the command 131 received by the first communicating module 114 to enable the active RFID tag 116 (step 240).

It should be mentioned that the format of the command sent by the second communicating module 134 includes the three fields of a verification number, an executing component, and an executing command. The datum in the verification number field contains the verification number of the portable electronic device that receives the command. The datum in the executing component field contains the component that is supposed to execute the command. The datum in the executing command field contains the command to be executed. In this embodiment, the ID field of the command 131 has the ID code “123456” of the portable electronic device 110. The executing component field is filled with the active RFID tag. The executing command field is filled with “start,” as shown in FIG. 3A.

According to the above description, when the portable electronic device 110 approaches the boundary of the first region and is about to enter the second region, the signal receiving module 112 and the active RFID tag 116 are both on. Therefore, whether the user of the portable electronic device 110 moves toward the first region or the second region at the next moment, the remote monitoring server 130 can immediately obtain his location.

After the user of the portable electronic device 110 enters the second region, the RFID reader 120 in the second region receives the ID code signal sent from the active RFID tag 116 and transmits an RF positioning signal to the remote monitoring server 130. The remote monitoring server 130 receives the RF positioning signal via the second communicating module 132 (step 250), and thereby finds out the location of the user of the portable electronic device 110.

It should be mentioned that after the remote monitoring server 130 receives the RF positioning signal, it sends a command 133 via the second communicating module 132 to the portable electronic device 110. The controlling module 118 of the portable electronic device 110 follows the command received by the first communicating module 114 to turn off the signal receiving module 112 (step 260), thus saving the power consumption of the portable electronic device 110. The ID field of the command 133 contains the verification number “123456” of the portable electronic device 110. The executing component field contains the “signal receiving module.” The executing command field is filled with “off,” as shown in FIG. 3B.

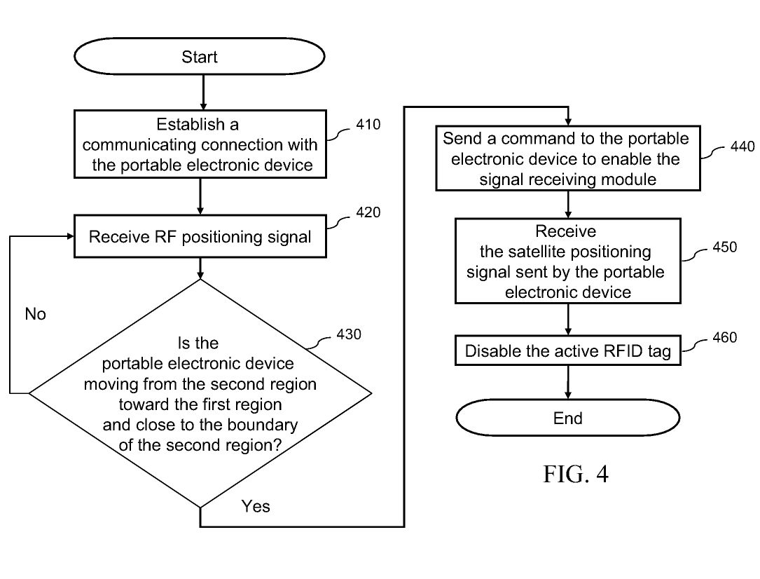

FIG. 4 is a flowchart showing the position tracking method in another embodiment of the invention. With reference to FIG. 4, suppose the initial state of the portable electronic device 110 is in the second region. The controlling module 118 only receives the RF positioning signal. The second communicating module 132 sends a command 133 to the portable electronic device 110, so that the controlling module 118 of the portable electronic device 110 follows the command 133 received by the first communicating module 114 to turn off the signal receiving module 112 and to enable the active RFID tag 116. In this case, the RFID reader 120 in the second region receives the ID code signal sent by the active RFID tag 116, and sends an RF positioning signal to the remote monitoring server 130. The remote monitoring server 130 receives the RF positioning signal via the second communicating module 132 (step 420) and, therefore, obtains the location of the user of the portable electronic device 110.

As described above, the communication distance between the RFID reader 120 and the active RFID tag 116 is limited. Therefore, the same second region (i.e., same indoor space) can be provided with several RFID readers 120. In particular, the position determining module 134 of the remote monitoring server 130 can determine which RFID reader 120 sends out the RF positioning signal received by the second communicating module 132. Therefore, it can accurately obtain the position of the user of the portable electronic device 110 in the indoor space. Also because of so, the remote monitoring server 130 can determine whether the user of the portable electronic device 110 is moving from the second region toward the first region and close to the boundary of the second region according to the RF positioning signal received by the second communicating module 132 using the position determining module 134 (step 430).

When the position determining module 134 determines that the user of the portable electronic device 110 is close to the boundary of the second region and about to enter the first region, the remote monitoring server 130 sends out a command 135 via the second communicating module 132. The command 135 is sent to the portable electronic device 110 via the communicating connection established in step 410. The controlling module 118 of the portable electronic device 110 enables the signal receiving module 112 (step 440). In particular, the ID field of the command 135 is filled with the verification number “123456” of the portable electronic device 110. The executing component field is filled with “the signal receiving module,” and the executing command field is filled with “start,” as shown in FIG. 3C.

After the user of the portable electronic device 110 enters the first region, the signal receiving module 112 can receive the satellite positioning signals emitted by satellites. The first communicating module 114 sends the satellite positioning signals to the remote monitoring server 130. The remote monitoring server 130 uses the second communicating module 132 to receive the satellite positioning signals (step 450), thereby determining the location of the user of the portable electronic device 110.

As described above, the remote monitoring server 130 can use the second communicating module 132 to transmit the command 137 to the portable electronic device 110. The controlling module 118 of the portable electronic device 110 disables the active RFID tag 116 according to the command 137 received by the first communicating module 114 (step 460), thereby saving the power of the portable electronic device 110. The ID field of the command 137 is filled with the verification number “123456” of the portable electronic device 110. The executing component field is filled with “the active RFID”. The executing command field is filled with “off,” as shown in FIG. 3D.

When the portable electronic device 110 is at the boundary between the first region and the second region, the controlling module 118 simultaneously enables the signal receiving module 112 and the active RFID tag 116. Therefore, regardless whether the portable electronic device 110 moves from the boundary between the first region and the second region to the first region or the second region, the remote monitoring server 130 can continuously receive the position information of the portable electronic device 110.

With further reference to FIGS. 1 and 2, after the user of the portable electronic device 110 moves from the first region to the second region, the position determining module 134 in the remote monitoring server 130 uses the RF positioning signal received in step 250 to determine whether the user of the portable electronic device 110 approaches from the second region to the first region. The detail is illustrated in FIG. 4, and is not repeated herein again.

Likewise, in the flowchart of FIG. 4, after the user of portable electronic device 110 moves from the second region to the first region, the position determining module 134 of the remote monitoring server 130 also uses the satellite positioning signals received in step 450 to determine whether the user of the portable electronic device 110 moves from the first region to the second region. The detail is illustrated in FIG. 2, and is not repeated herein again.

In particular, when the communication between the portable electronic device 110 and the remote monitoring server 130 breaks, i.e., when the first communicating module 114 of the portable electronic device 110 cannot transmit the satellite positioning signals received by the signal receiving module 112 to the remote monitoring server 130, the controlling module 118 of the portable electronic device 110 simultaneously enables the signal receiving module 112 and the active RFID tag 116. Once the communication between the portable electronic device 110 and the remote monitoring server 130 resumes, the position information of the portable electronic device 110 can be immediately provided to the remote monitoring server 130. It is worth mentioning that after the controlling module 118 simultaneously enables the signal receiving module 112 and the active RFID tag 116, the portable electronic device 110 records the coordinates in the satellite positioning signals received by the signal receiving module 112. Once the portable electronic device 110 and the remote monitoring server 130 subsequently resume the connection, the coordinate information is transmitted to the remote monitoring server 130 to make up information loss when the communication is broken.

Although the invention has been described with reference to specific embodiments, this description is not meant to be construed in a limiting sense. Various modifications of the disclosed embodiments, as well as alternative embodiments, will be apparent to persons skilled in the art. It is, therefore, contemplated that the appended claims will cover all modifications that fall within the true scope of the invention.

What is claimed is:

1. A position tracking system, comprising:
a portable electronic device, having a signal receiving module, a first communicating module, an active radio frequency identification (RFID) tag and a controlling module, the signal receiving module receiving a satellite positioning signal in a first region, the first communicating module emitting the satellite positioning signal, the active RFID tag emitting an identification (ID) code signal, and the controlling module enabling/disabling the signal receiving module and the active RFID tag;
at least one RFID reader, being located in a second region for receiving the ID code signal emitted by the active RFID tag, and emitting an radio frequency (RF) positioning signal after receiving the ID code signal; and
a remote monitoring server, comprising:
a second communicating module, establishing a communicating connection with the first communicating module for receiving the satellite positioning signal emitted by the first communicating module and for receiving the RF positioning signal emitted by the RFID reader; and
a position determining module, using the satellite positioning signal received by the second communicating module to determine whether the portable electronic device is far from the first region and close to the second region when the controlling module enables the signal receiving module;
wherein the remote monitoring server sends a first command via the second communicating module to the first communicating module when the portable electronic device is close to the second region, and the controlling module enables the active RFID tag according to the first command received by the first communicating module.

2. The position tracking system of claim 1, wherein after the controlling module enables the active RFID tag and the second communicating module receives the RF positioning signal, the remote monitoring server sends a second command to the first communicating module via the second communicating module and the controlling module disables the signal receiving module following the second command received by the first communicating module.

3. The position tracking system of claim 1, wherein the position determining module uses the RF positioning signal received by the second communicating module to determine whether the portable electronic device is far from the second region and close to the first region when the controlling module enables the active RFID tag, the remote monitoring server sends a third command via the second communicating module to the first communicating module when the portable electronic device is close to the first region, and the controlling enables the signal receiving module following the third command received by the first communicating module.

4. The position tracking system of claim 3, wherein after the controlling module enables the signal receiving module and the second communicating module receives the satellite positioning signal, the remote monitoring server sends a fourth command via the second communicating module to the first communicating module and the controlling module disables the active RFID tag following the fourth command received by the first communicating module.

5. The position tracking system of claim 1, wherein the controlling module simultaneously enables the signal receiving module and the active RFID tag when no communicating connection is established between the first communicating module and the second communicating module.

6. A position tracking system, comprising:
a portable electronic device, which includes:
a signal receiving module, which receives a satellite positioning signal in a first region;
a first communicating module, which establishes a communicating connection with a remote monitoring server and sends the satellite positioning signal to the remote monitoring server;
an active radio frequency identification (RFID) tag, which emits an identification (ID) code signal; and
a controlling module, which enables/disables the signal receiving module and the active RFID tag; and
at least one RFID reader, which is located in a second region for receiving the ID code signal emitted by the active RFID tag and, after receiving the ID code signal, emits an radio frequency (RF) positioning signal;
wherein the remote monitoring server includes:
a second communicating module, which establishes a communicating connection with the first communicating module for receiving the satellite positioning signal emitted by the first communicating module and for receiving the RF positioning signal emitted by the RFID reader; and
a position determining module, which uses the RF positioning signal received by the second communicating module to determine whether the portable electronic device is far from the second region and close to the first region when the controlling module enables the active RFID tag; wherein the remote monitoring server sends a third command via the second communicating module to the first communicating module when the portable electronic device is close to the first region, and the controlling module enables the signal receiving module according to the third command received by the first communicating module.

7. The position tracking system of claim 6, wherein after the controlling module enables the signal receiving module and the second communicating module receives the satellite positioning signal, the remote monitoring server sends a fourth command via the second communicating module to the first communicating module and the controlling module disables the active RFID tag following the fourth command received by the first communicating module.

8. The position tracking system of claim 6, wherein the controlling module simultaneously enables the signal receiving module and the active RFID tag when no communicating connection is established between the first communicating module and the second communicating module.

9. A portable electronic device used for communicating with a remote monitoring system, comprising:
a signal receiving module, which receives a satellite positioning signal in a first region;
a first communicating module, which establishes a communicating connection with the remote monitoring system and sends the satellite positioning signal to the remote monitoring system;
an active RFID tag, which sends an ID code signal for at least one RFID reader in a second region to read, the RFID reader sending an RF positioning to the remote monitoring system after reading the ID code signal; and
a controlling module, which enables/disables the signal receiving module and the active RFID tag;
wherein when the remote monitoring system determines that the portable electronic device is far from the first region and close to the second region, the remote monitoring system sends a first command to the first communicating module and the controlling module enables the active RFID tag following to the first command received by the first communicating module.

10. The portable electronic device of claim 9, wherein after the controlling module enables the active RFID tag and the remote monitoring system receives the RF positioning signal, the remote monitoring system sends a second command to the first communicating module and the controlling module disables the signal receiving module following the second command received by the first communicating module.

11. The portable electronic device of claim 9, wherein when the remote monitoring system determines that the portable electronic device is far from the second region and close to the first region, the remote monitoring system sends out a third command to the first communicating module an the controlling module enables the signal receiving module following the third command received by the first communicating module.

12. The portable electronic device of claim 11, wherein after the controlling module enables the signal receiving module and the remote monitoring system receives the satellite positioning signal, the remote monitoring system sends a fourth command to the first communicating module and the controlling module disables the active RFID tag following the fourth command received by the first communicating module.

13. The portable electronic device of claim 11, wherein the controlling module simultaneously enables the signal receiving module and the active RFID tag when no communicating connection is established between the first communicating module and the remote monitoring system.

14. A position tracking method for tracking the position of a portable electronic device that has a signal receiving module to receive a satellite positioning signal in a first region and an active RFID tag to send an ID code signal for at least one RFID reader in a second region to read, the RFID reader sending an RF positioning signal after receiving the ID code signal, the method comprising the steps of:
establishing a communicating connection with the portable electronic device;
receiving the satellite positioning signal sent by the portable electronic device;
determining whether the portable electronic device is far from the first region and close to the second region according to the satellite positioning signal; wherein when the portable electronic device is far from the first region and close to the second region, a first command is sent to the portable electronic device to enable the active RFID tag for sending the ID code signal to the RFID reader; and
receiving the RF positioning signal sent by the RFID reader.

15. The position tracking method of claim 14 further comprising the step of sending a second command to the portable electronic device to disable the signal receiving module after the RF positioning signal is received.

16. The position tracking method of claim 15, wherein the step of disabling the signal receiving module is followed by the steps of:
determining whether the portable electronic device is far from the second region and close to the first region according to the RF positioning signal;
wherein when the portable electronic device is far from the second region and close to the first region, a third command is sent to the portable electronic device to enable the signal receiving module; and
receiving the satellite positioning signal.

17. The position tracking method of claim 16, wherein the step of receiving the satellite positioning signal is followed by the step of sending a fourth command to the portable electronic device to disable the active RFID tag.

18. The position tracking method of claim 16, wherein the portable electronic device simultaneously enables the signal receiving module and the active RFID tag when the communicating connection breaks.
